(19) United States
(12) Patent Application Publication
(10) Pub. No.: US 2009/0066477 A1
(43) Pub. Date: Mar. 12, 2009

(54) AUTHENTICATION APPARATUS

(75) Inventors: Hiroki Kaihori, Osaka (JP); Hiroyasu Okada, Hyogo (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/911,433

(22) PCT Filed: Aug. 28, 2006
(86) PCT No.: PCT/JP2006/316852

§ 371 Date: Oct. 12, 2007

(30) Foreign Application Priority Data
Aug. 30, 2005 (JP) 2005-248964

(51) Int. Cl. G08B 29/00

(52) U.S. Cl. 340/5.72

(57) ABSTRACT

The authentication apparatus disclosed here is formed of a unit to be controlled and a plurality of portable devices having communication with the unit via radio waves. The unit has a first controller, a first transmitter controlled by the first controller and a first receiver. Each of the portable devices has a second controller, a storage section that stores the replying order of the portable devices and is controlled by the second controller, a second transmitter and a second receiver. In response to communication signals sent from the first transmitter of the unit to each of the second receivers, each portable device replies with a first communication signal according to the replying order stored in the storage section. The first communication signal is sent back to the unit from each device with a predetermined time difference so as not to produce an overlapped period in the replying time.

### TECHNICAL FIELD

The present invention relates to authentication apparatus used for a car-locking system.

### BACKGROUND ART

In recent years, a portable device for locking/unlocking a car via radio waves has become commercially practical. In such a car-locking system, the portable device stores an identification information number (hereinafter, an ID number) specific to the car. Receiving the ID number, the car-locking system carries out authentication and unlocks the door if it checks out.

For example, Japanese Patent Unexamined Publication No. 2003-20837 is known as a prior art relating to the present invention.

In the car-locking system above, more-than-one portable devices are provided for family use; the system carries out authentication for plural devices. To be specific, communication signals are transmitted to the portable devices from the car-locking system. Receiving the signal, each device sends a reply signal back to the system. In such a car-locking system employing plural portable devices, however, it takes time before unlocking the car.

Suppose that six portable devices communicate with a car-locking system, as shown in FIG. 5, and devices 5a and 6a are in the vicinity of the car-locking system. In this case, the system receives reply signals from devices 5a and 6a and no reply from devices 1a through 4a. The reply signals simultaneously sent from devices 5a and 6a cause a signal collision. As a result, the system detects presence of a portable device by intensity of receiving signal, but cannot identify the devices.

To identify the adjacent device, the car-locking system firstly sends individual authentication call to portable device 1a. When having no reply from device 1a, the system carries out the authentication calling one after another, i.e., devices 2a, 3a, 4a and so on. In the sequential calling, reply from portable device 5a tells the system that device 5a is adjacent to the car. ECU in FIG. 3 stands for electronic control unit.

The aforementioned car-locking system, because of having a plurality of portable devices, takes long time until completing authentication.

### SUMMARY OF THE INVENTION

The authentication apparatus of the present invention is formed of a unit to be controlled and a plurality of portable devices communicating with the unit via radio waves. The unit to be controlled has a first controller, a first transmitter controlled by the first controller, and a first receiver. Each of portable devices has a second controller, a storage section that stores a replying order of the portable devices and is controlled by the second controller, a second transmitter, and a second receiver. In response to communication signals sent from the first transmitter of the unit to each of the second receivers, each portable device sends a first communication signal according to the replying order stored in the storage section. The first communication signal is sent back to the unit from each device with a predetermined time difference so as not to produce an overlapped period in the replying time. By virtue of the communication with a predetermined time difference, the first controller of the unit quickly recognizes an adjacent portable device, significantly reducing the time required to complete authentication.

### BRIEF DESCRIPTION OF THE DRAWINGS

FIG. 1 is a block diagram showing the controller of authentication apparatus in accordance with an exemplary embodiment of the present invention.

FIG. 2 is a plan view of the authentication apparatus of the exemplary embodiment.

FIG. 3 illustrates a sequence of authentication in the authentication apparatus of the exemplary embodiment.

FIG. 4A shows the structure of a reply signal from a portable device when the signal is judged by receiving electric field intensity in the authentication apparatus of the exemplary embodiment.

FIG. 4B shows the structure of a reply signal from a portable device when the signal is judged by data in the authentication apparatus of the exemplary embodiment.

FIG. 4C shows the structure of a reply signal from a portable device when the signal is judged by parity of a portable device-specific number in the authentication apparatus of the exemplary embodiment.

FIG. 4D shows the structure of a reply signal from a portable device when the signal is judged by synchronizing signals that differ from signals for one-way authentication and parity of a portable device-specific number in the authentication apparatus of the exemplary embodiment.

FIG. 5 illustrates a sequence of authentication in conventional authentication apparatus.

### REFERENCE MARKS IN THE DRAWINGS

1 car body
2 engine room
3 interior
4 trunk
5, 6 door
7, 8, 9 seat
10, 11 interior transmitting antenna
12, 13, 14 exterior transmitting antenna
15 steering wheel
16 receiving antenna
17 portable device
18 first transmitter
19 first controller
20 first receiver
21 door-locking section
22 receiving antenna
23 second receiver
24 second controller
25 transmitting antenna
26 second transmitter
27 storage section
28 storage section
30 car-locking system (unit to be controlled)

### DETAILED DESCRIPTION OF THE PREFERRED EMBODIMENTS

### Exemplary Embodiment

An exemplary embodiment of the present invention will be described hereinafter with reference to accompanying drawings. The description below shows an example where the structure described in the embodiment is mounted on a car.

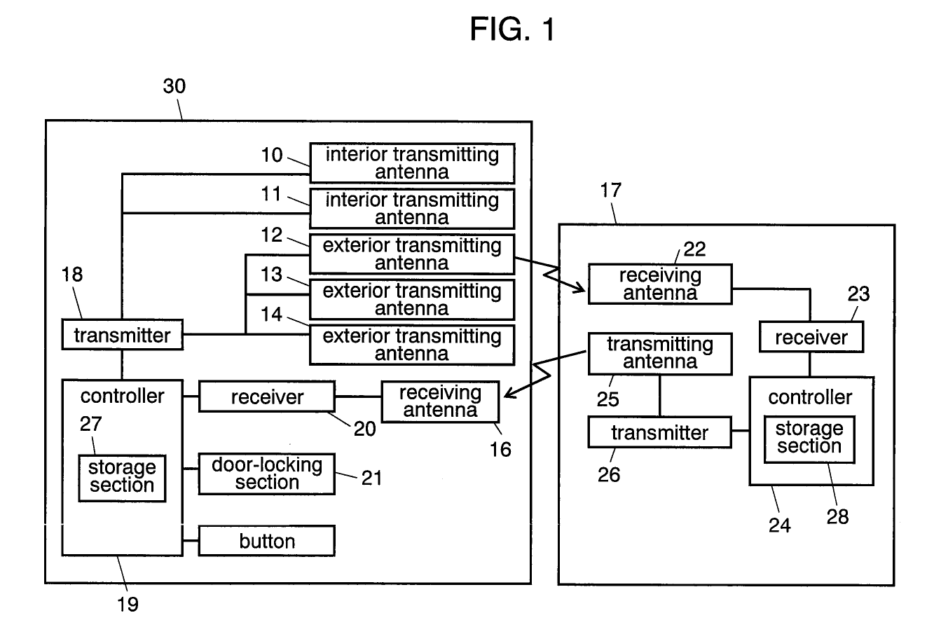

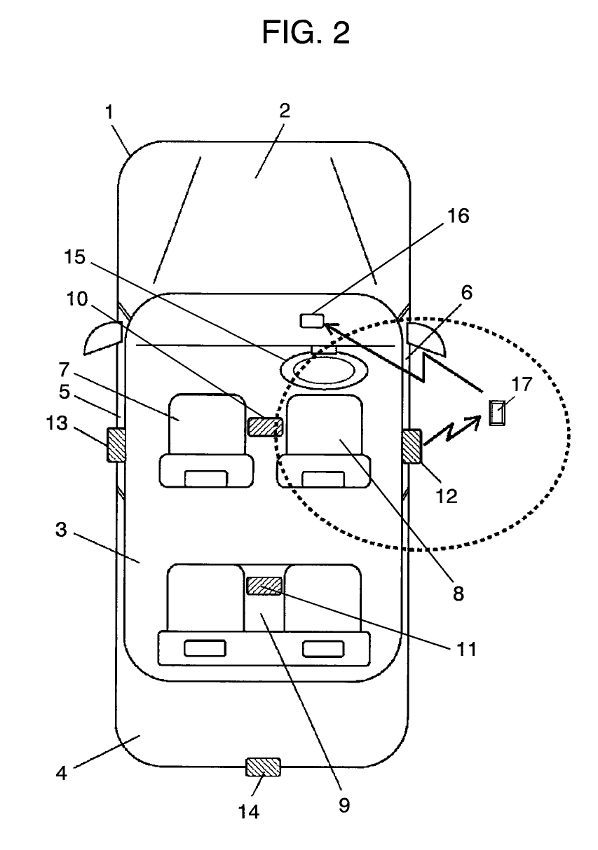

FIGS. 1 and 2 show an exemplary embodiment of the present invention. As shown in FIGS. 1 and 2, car body 1 has engine room 2 in the front section, interior 3 and trunk 4. In the interior 3, doors 5 and 6 are disposed at the left front and the right front, respectively. Besides, seats 7 and 8 are disposed in the front of interior 3 and seat 9 is disposed in the back of interior 3.

Here will be described car-locking system 30 and portable device 17 shown in FIG. 1. Portable device 17 communicates, via radio waves, with car-locking system 30 as a unit to be controlled.

Interior transmitting antenna 10 is disposed between front seats 7 and 8. Interior transmitting antenna 11 is disposed at back seat 9. On the other hand, exterior transmitting antenna 12 is attached on door 6 and exterior transmitting antenna 13 is attached on door 5. Exterior transmitting antenna 14 is attached on trunk 4. Steering wheel 15 and receiving antenna 16 are disposed in front of seat 8 in interior 3. Portable device 17 shown in FIG. 2 is practically formed into a portable key. FIG. 1 shows a detailed structure of the control section of the structure in FIG. 2.

Interior transmitting antennas 10 and 11 are connected to first transmitter 18 and first controller 19. Exterior transmitting antennas 12, 13 and 14 are also connected to transmitter 18. Receiving antenna 16 is connected to first receiver 20. Door-locking section 21, which locks/unlocks door 6, is connected to controller 19.

Portable device 17 has receiving antenna 22, second receiver 23, second controller 24, transmitting antenna 25 and second transmitter 26. Controller 19 of car-locking system 30 has storage section 27 that stores reference data used for comparison with data sent from portable device 17. On the other hand, portable device 17 has storage section 28 that stores data specific to the device. For example, storage section 27 stores which portable device has replied, and storage section 28 stores the replying order of the portable device. Storage sections 27 and 28 are formed of nonvolatile storage, such as EEPROM, or formed of volatile storage, such as RAM.

In the structure above, controller 19 of the car-locking system regularly communicates with portable device 17 via exterior transmitting antennas 12, 13 and 14. When portable device 17 is close to the car, device 17 receives the communication signal through receiving antenna 22. Controller 24 sends a reply signal to controller 19 via transmitter 26 and transmitting antenna 25. The reply signal has a time difference according to the replying order stored in storage section 28. Receiving the reply signal by receiving antenna 16 of car body 1, controller 19 knows, from the received time difference, which portable device has replied.

Controller 19 of car body 1 sends an individual authentication call signal to portable device 17 via transmitter 18 and exterior transmitting antenna 12. In the calling operations, controller 19 uses potable device-specific data stored in storage section 27. Receiving the call signal by receiving antenna 22, controller 24 of portable device 17 checks whether the call signal agrees with a predetermined value with reference to the specific data stored in storage section 28. If the received data matches with the predetermined value, controller 24 sends individual authentication reply with the use of portable device-specific data via transmitter 26 and transmitting antenna 25. Receiving the reply by receiving antenna 16 of car body 1, controller 19 checks the authentication reply for normality, with reference to the portable device-specific data stored in storage section 27. If the normality is confirmed, controller 19 judges that the authentication successfully completes and unlocks the door.

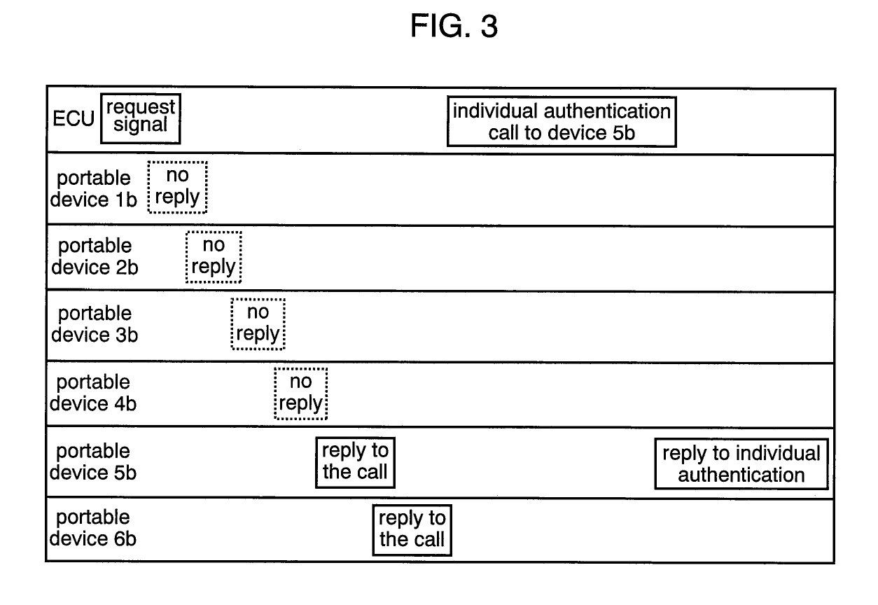

Although portable device 17 is shown as a single device in FIG. 2, more-than-one devices are often provided for family use. For example, FIG. 3 shows a communicating sequence of authentication between the car-locking system and six portable devices 1b through 6b. When portable devices 5b and 6b are close to the car, the two devices receive the call signal fed from exterior transmitting antenna 12 almost at the same time; however, there is a time difference in the replying process between device 5b and device 6b. That is, device 5b sends the reply earlier than device 6b and device 6b does not send the reply before completion of the reply from device 5b so that the communication signal (i.e., first communication signal) is exchanged with no overlapping in replying time of portable devices.

Although the exemplary embodiment introduces a smart keyless system where the car-locking system communicates with portable device 17 (devices 1b through 6b) coming close to the car and the doors are locked/unlocked if the authentication is successfully completed, it is not limited thereto. In the smart keyless system of the present invention, the communication between the car-locking system and the portable device in prior to the authentication may be triggered by the following actions: depressing a button disposed on doors 5 and 6; touching a touch sensor.

As an aspect of the structure of the embodiment, when the car-locking system communicates with six portable devices 1b through 6b, the numbers 1 to 6 are assigned to the six devices as a replying order. The car-locking system communicates with each device in a way that each portable device replies with a predetermined time difference to the car-locking system according to the replying order. As a result, the communication is successively carried out between the system and each device, with no overlapped replies between the devices.

As another aspect of the structure of the embodiment, when the car-locking system communicates with portable devices up to six in number, the maximum number for the replying order is set to 6.

As still another aspect of the structure, all the portable devices can reply to the car-locking system with a predetermined same data.

As yet another aspect of the structure, in six portable devices 1b through 6b, a portable device placed earlier in the replying order has a shorter reply signal.

As another aspect of the structure, the car-locking system starts individual authentication with a firstly replied portable device.

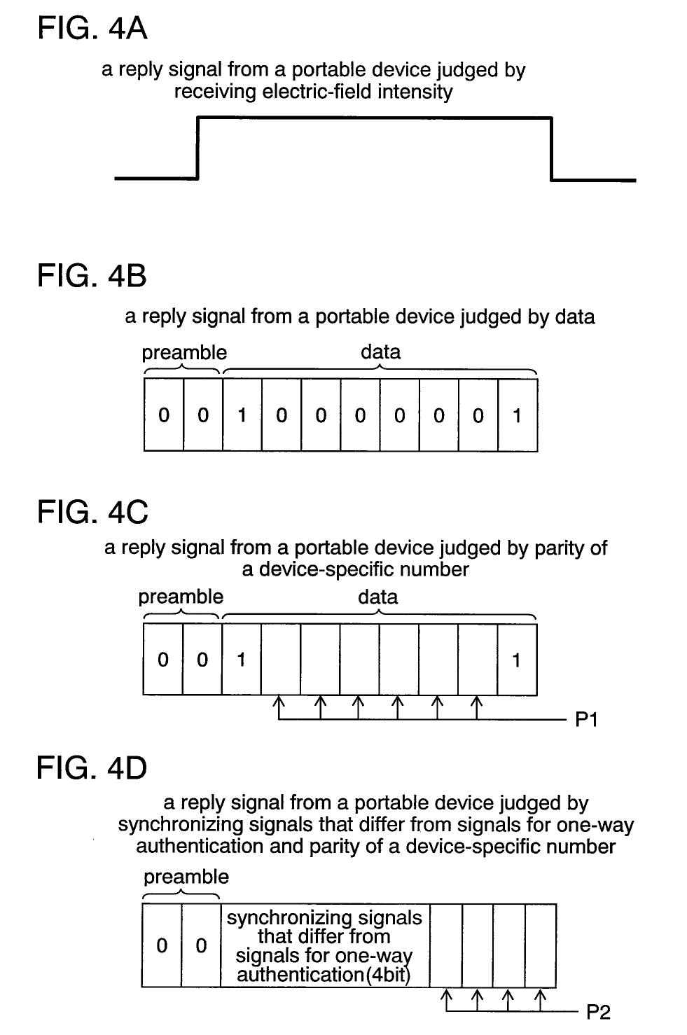

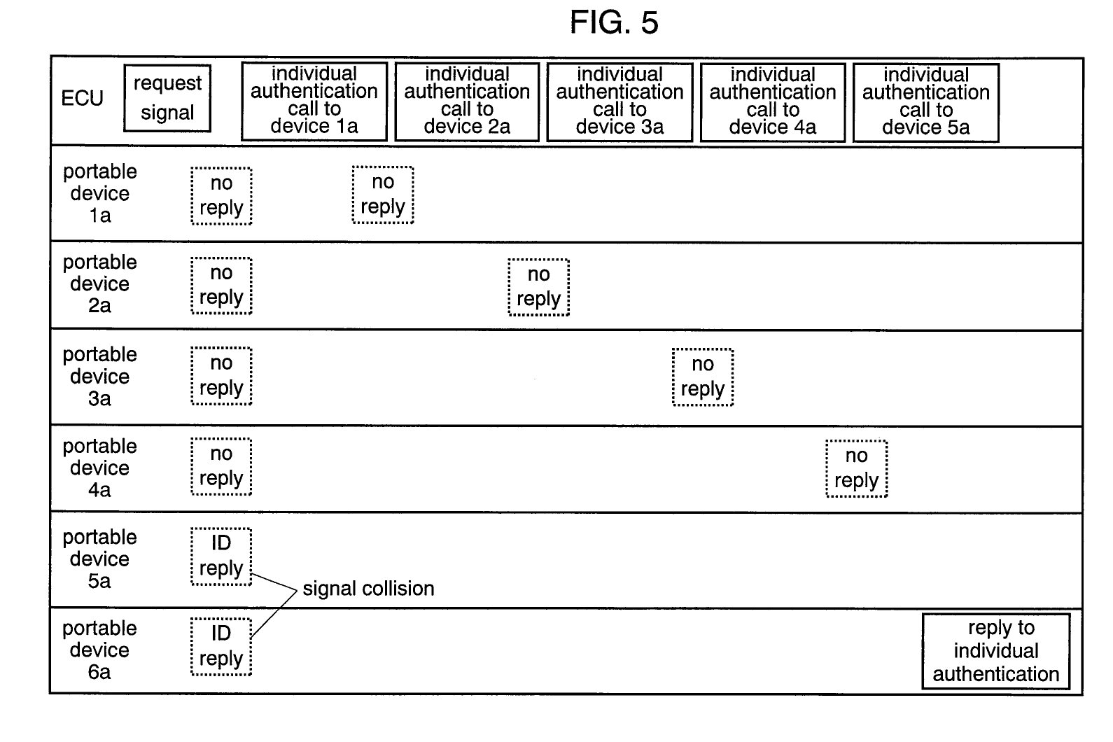

As still another aspect of the structure, when receiving a reply signal having a receiving electric-field intensity within a predetermined range (as is shown in FIG. 4A), the car-locking system stores the device into storage section 27. The system carries out individual authentication with a firstly replied portable device; if the authentication has no success, the system successively carries out the individual authentication on all the devices in storage section 27 until having success in the authentication.

As yet another aspect of the structure, when receiving a reply signal having a predetermined data (as is shown in FIG. 4B), the car-locking system stores the device into storage section 27. The system carries out individual authentication with a firstly replied portable device; if the authentication has no success, the system successively carries out the individual authentication on all the devices in storage section 27 until having success in the authentication.

As another aspect of the structure, the time for waiting reply signals from the portable devices can be changed according to the number of the portable devices. That is, for communication with three portable devices, the system has a waiting time enough for three, and for communication with six devices, the system has a waiting time enough for six.

As still another aspect of the structure, the system carries out individual authentication with the use of a device-specific number that is given separately from the numbers representing the replying order of the devices.

As yet another aspect of the structure, in the communication that employs a reply signal having a structure shown in FIG. 4C, when a device-specific number of a portable device—which is given separately from a number representing the replying order—has complete agreement in parity every predetermined bits, the car-locking system stores the device in storage section 27. The system starts individual authentication with a firstly replied portable device; if the authentication has no success, the system successively carries out the individual authentication one after another on all the devices in storage section 27 until having success in the authentication. In FIG. 4C, ‘P1’ represents parity every 4 bits of a device-specific ID number (24-bit data).

As another aspect of the structure, the car-locking system carries out locking operations by using not only the aforementioned two-way authentication between the car-locking system and the portable devices but also another one-way authentication from a device to the system. In this case, the synchronizing signal included in the transmitting signal in the one-way authentication above differs from the synchronizing signal in the reply signal of FIG. 4D and also differs from the format of data included in the one-way transmitting signal. In FIG. 4D, ‘P2’ represents parity every 6 bits of a device-specific ID number (24-bit data).

As still another aspect of the structure, a preamble signal, which is a string of same data included in the one-way transmitting signal, differs from the reply signal.

According to car-locking system 30 shown in FIG. 1, first receiver 20 controlled by first controller 19 effects door-locking/unlocking control with the use of a second communication signal fed from portable device 17. The first communication signal may contain a synchronizing signal different from a signal and data included in the second communication signal. Besides, the first communication signal may include data different from a preamble signal included in the second communication signal.

Here will be described effects brought by the authentication apparatus of the exemplary embodiment.

The authentication apparatus of the present invention is formed of a unit to be controlled and a plurality of portable devices communicating with the unit via radio waves. The unit to be controlled has a first controller, a first transmitter controlled by the first controller, and a first receiver. Each of portable devices has a second controller, a storage section that stores a replying order of the portable devices and is controlled by the second controller, a second transmitter, and a second receiver. In response to communication signals sent from the first transmitter of the unit to each of the second receivers, each portable device sends a first communication signal according to the replying order stored in the storage section. The first communication signal is sent back to the unit from each device with a predetermined time difference so as not to produce an overlapped period in the replying time. With the structure above, the authentication apparatus easily detects a portable device close to the unit to be controlled.

A structure of the embodiment has the following aspect:
the first communication signal is successively sent back to the unit from a plurality of portable devices with a predetermined time difference so as not to produce an overlapped period in replying time of the devices.

With the structure above, the replying time required for the portable devices can be shortened.

A structure of the embodiment has the following aspect:
the numbers representing the replying order stored in the storage section of the portable device do not take an identical number with one another, but take sequential numbers, starting with a predetermined number.

With the structure above, the replying process can be started with the device having the predetermined number and then successively carried out one after another. This shortens the replying time of the devices.

A structure of the embodiment has the following aspect:
the maximum value of the numbers representing the replying order stored in the storage section of a portable device is determined to be equal to the maximum number of the portable devices that communicate with the unit to be controlled.

With the structure above, a number greater than the maximum number can be detected as wrong data.

A structure of the embodiment has the following aspect:
all the portable devices can reply to the car-locking system with the first communication signal formed of a predetermined same data.

With the structure above, there is no need to set different data to each device.

A structure of the embodiment has the following aspect:
the portable device do not have a uniform first communication signal; a device placed earlier in the replying order has a shorter form of the first communication signal.

With the structure above, the time required for all devices to complete replying can be shortened.

A structure of the embodiment has the following aspect:
the first controller of the unit carries out authentication with the firstly replied portable device when the first communication signals are sent back with a predetermined time difference from a plurality of portable devices.

With the structure above, the time required to complete authentication can be shortened because the device has already been identified prior to the authentication.

A structure of the embodiment has the following aspect:
the unit to be controlled has a storage section for storing a portable device;
when the first receiver of the unit receives a first communication signal having a receiving electric-field intensity within a predetermined range in a communication with a predetermined time difference with a plurality of portable devices, the first controller of the unit stores the device in the storage section and carries out authentication with a firstly replied portable device.

With the structure above, a portable device adjacent to the unit can be identified. This is because the first controller stores a portable device on condition that receiving electric-field intensity of the first communication signal from the device is kept within a predetermined range.

A structure of the embodiment has the following aspect:
the unit to be controlled has a storage section for storing a portable device;
when the first receiver of the unit receives a first communication signal having a predetermined data in a communication with a predetermined time difference with a plurality of portable devices, the first controller of the unit stores the device in the storage section and carries out authentication with a firstly replied portable device.

With the structure above, the controller stores a portable device on condition that the first communication signal from the device has a predetermined data, and therefore, a portable device without meeting condition above can be omitted.

A structure of the embodiment has the following aspect:
the time for waiting the first communication signal from the portable devices can be changed according to the number of the portable devices that communicate with the unit to be controlled.

With the structure above, the time for waiting the first communication signal is determined to be longer when the unit communicates with larger in number portable devices, whereas the time is determined to be shorter when the unit communicates with smaller in number portable devices. This eliminates waste from the time for waiting signals.

A structure of the embodiment has the following aspect:
the authentication of portable devices is carried out with the use of a device-specific number that is given separately from the numbers representing the replying order of the devices.

The authentication with the use of a device-specific number increases the level of security.

A structure of the embodiment has the following aspect:
the first communication signal includes a plurality of parity bits in a device-specific number every predetermined bits;
when the first receiver of the unit receives a first communication signal having complete agreement in parity every predetermined bits of a device-specific number in a communication with a predetermined time difference with a plurality of portable devices, the first controller of the unit stores the device in the storage section and carries out authentication with a firstly replied portable device.

With the use of the first communication signal having a plurality of parity bits in a device-specific number, a portable device with no agreement in parity can be omitted.

A structure of the embodiment has the following aspect:
the unit is employed for a locking system of a car.

The structure serves as a car-locking system.

A structure of the embodiment has the following aspect:
the first receiver controlled by the first controller effects door-locking/unlocking control with the use of second communication signal fed from a portable device;
the first communication signal contains a synchronizing signal different from a signal and data included in the second communication signal.

With the structure above, the first communication signal can be easily distinguished from the second communication signal.

A structure of the embodiment has the following aspect:
the first communication signal has data that is different from a preamble signal included in the second communication signal.

With the structure above, the first communication signal can be easily distinguished from the preamble signal of the second communication signal.

### INDUSTRIAL APPLICABILITY

According to the structure of the present invention, as described above, a plurality of portable devices send back, with a predetermined time difference, communication signals to the unit so as not to produce an overlapped period in the replying time. This allows the unit to have a speedy authentication,

1. Authentication apparatus comprising:
a unit to be controlled; and
a plurality of portable devices communicating with the unit via radio waves, the unit to be controlled further including:
a first controller;
a first transmitter controlled by the first controller;
a first receiver, and
a storage section for storing the portable devices,
the plurality of portable devices, each of which further including:
a second controlled;
a storage section that stores a replying order of the portable devices and is controlled by the second controller;
a second transmitter; and
a second receiver,
wherein, in response to communication signals sent from the first transmitter of the unit to the second receiver, the portable devices send a first communication signal according to the replying order stored in the storage section, the first communication signal is sent back to the unit from each portable device with a predetermined time difference so as not to produce an overlapped period in replying time, when the first receiver of the unit receives the first communication signal having a predetermined data from a portable device in a communication with a predetermined time difference with the portable devices, the first controller of the unit stores the portable device in the storage section and carries out authentication with a firstly replied portable device.

2. The authentication apparatus of claim 1, wherein the first communication signal is successively sent back to the unit from each portable device with a predetermined time difference so as not to produce an overlapped period in replying time.

3. The authentication apparatus of claim 1, wherein numbers representing the replying order stored in the storage section of the portable devices do not take an identical number with one another but take sequential numbers, starting with a predetermined number.

4. The authentication apparatus of claim 1, wherein a maximum value of the numbers representing the replying orders stored in the storage section of the portable devices is determined to be equal to a maximum number of the portable devices the communicate with the unit.

5. The authentication apparatus of claim 1, wherein all the portable devices reply to the unit with the first communication signal formed of a predetermined same data.

6. The authentication apparatus of claim 1, wherein the portable devices do not have a uniform first communication signal; a portable device placed earlier in the replying order has a shorter form of the first communication signal.

7. The authentication apparatus of claim 1, wherein the first controller of the unit carries out authentication with a firstly replied portable device when the first communication signals are sent back with a predetermined time difference from the portable devices.

8. The authentication apparatus of claim 1, wherein the unit has a storage section for storing a portable device, when the first receiver of the unit receives the first communication signal having a receiving electric-field intensity within a predetermined range in a communication with a predetermined time difference with the portable devices, the first controller of the unit stores the device in the storage section and carries out authentication with a firstly replied portable device.

9. (canceled)

10. The authentication apparatus of claim 1, wherein a time for waiting the first communication signal from the portable devices is changed according to the number of the portable devices that communicate with the unit.

11. The authentication apparatus of claim 1, wherein authentication of the portable devices is carried out with the use of a device-specific number that is given separately from the numbers representing the replying order of the devices.

12. The authentication apparatus of claim 1, wherein the first communication signal includes a plurality of parity bits in a device-specific number every predetermined bits, when the first receiver of the unit receives the first communication signal having complete agreement in parity every predetermined bits of the device-specific number in a communication with a predetermined time difference with the portable devices, the first controller of the unit stores the device in storage section and carries out authentication with a firstly replied portable device.

13. The authentication apparatus of claim 1, wherein the unit is employed for a locking system of a car.

14. The authentication apparatus of claim 13, wherein the first receiver controlled by the first controller effects door-locking/unlocking control with the use of a second communication signal sent from a portable device, the first communication signal contains a synchronizing signal different from a signal and data included in the second communication signal.

15. The authentication apparatus of claim 14, wherein the first communication signal has data that is different from a preamble signal included in the second communication signal.
